(19) United States
(12) Patent Application Publication
(10) Pub. No.: US 2007/0283275 A1
(43) Pub. Date: Dec. 6, 2007

(54) System and method for instructing a processor to reposition desktop icons

(76) Inventor: Syed Aamer Azam, Union City, CA (US)

Correspondence Address: FLIESLER MEYER LLP, 650 CALIFORNIA STREET, 14TH FLOOR, SAN FRANCISCO, CA, 94108, US

(21) Appl. No.: 11/443,622

(22) Filed: May 31, 2006

(51) Int. Cl. G06F 3/00

(52) U.S. Cl. 715/745; 715/748

(57) ABSTRACT

In accordance with embodiments, there are provided mechanisms and methods for instructing a processor to reposition desktop icons. These mechanisms and methods for instructing a processor to reposition desktop icons can enable embodiments to provide a screen at a computer system using information from another computer system and a portable storage device. The ability of embodiments to provide a screen at a computer system using information from another computer system and a portable storage device can enable users to simulate the experience of working on their own computer while working at an away computer.

### CROSS REFERENCE TO RELATED APPLICATIONS

The following commonly owned, co-pending U.S. Patents and Patent Applications, including the present application, are related to each other. Each of the other patents/applications are incorporated by reference herein in their entirety:

U.S. patent application Ser. No. 10/435,070 entitled SYSTEM AND METHOD FOR TRANSFERRING PERSONALIZATION INFORMATION AMONG COMPUTER SYSTEMS by Levine, et al., filed May 8, 2003 (Attorney Docket No. MIGO-1004US0);

U.S. patent application Ser. No. ______ entitled SYSTEM AND METHOD FOR TRANSFERRING PERSONALIZATION INFORMATION AMONG COMPUTER SYSTEMS, by David Brett Levine et al., filed on ______, 20XX (Attorney Docket No. MIGO-1004US1);

U.S. patent application Ser. No. ______ entitled SYSTEM AND METHOD FOR TRANSFERRING PERSONALIZATION INFORMATION AMONG COMPUTER SYSTEMS, by David Brett Levine et al., filed on ______, 20XX (Attorney Docket No. MIGO-1004US2);

U.S. patent application Ser. No. ______ entitled SYSTEM AND METHOD FOR TRANSFERRING PERSONALIZATION INFORMATION AMONG COMPUTER SYSTEMS, by David Brett Levine et al., filed on ______, 20XX (Attorney Docket No. MIGO-1004US3);

U.S. patent application Ser. No. ______ entitled SYSTEM AND METHOD FOR TRANSFERRING PERSONALIZATION INFORMATION AMONG COMPUTER SYSTEMS, by David Brett Levine et al., filed on ______, 20XX (Attorney Docket No. MIGO-1004US4);

U.S. patent application Ser. No. ______ entitled SYSTEM AND METHOD FOR TRANSFERRING PERSONALIZATION INFORMATION AMONG COMPUTER SYSTEMS, by David Brett Levine et al., filed on ______, 20XX (Attorney Docket No. MIGO-1004US5); and

U.S. patent application Ser. No. ______ entitled SYSTEM AND METHOD FOR INSTRUCTING A PROCESSOR TO REPOSITION DESKTOP ITEMS, by Syed Aamer Azam et al., filed on May 31, 2006 (Attorney Docket No. MIGO-1009US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to managing personalization information for use with computing systems, and more particularly to a mechanism for instructing a processor to reposition desktop icons.

### BACKGROUND

Computer systems store files and allow users to process those files. The display of the names and other information about files stored on a computer system may be made via a user interface provided by an operating system. Because the number of files stored on a computer system can be significant, various ways of organizing the files stored on a computer system have been employed to make it easier for a user to locate file.

For example, the conventional Windows XP™ operating system by Microsoft Corporation employs a hierarchy of folders containing files assigned by users or application programs to one of the folders. This allows files to be logically grouped in a manner that facilitates locating any such file.

Although this approach facilitates the location of files from the many files that are stored on the computer system, the user must locate the files in the hierarchy, a cumbersome task. To simplify the task of locating the most used files, some operating systems such as Windows XP, allow users to define shortcuts or other desktop icons that will remain on the operating system “desktop”, which is the main screen displayed by the operating system from which files may be located. Because the shortcuts are on the desktop, they may be accessed by clicking on them, without searching through any hierarchy, an arrangement users find far more convenient than searching for files through layers of a hierarchy and then accessing the file by clicking on it. When a user clicks on the shortcut to the file, the operating system will then start the application program associated with that file and cause the application program to open the file. Although some shortcuts have to be set up by the user in advance of their use, if the file will be used a number of times by the user, it can be worth the overhead of arranging the shortcuts onto the desktop.

Although the number of shortcuts that can be displayed on the desktop is limited by the size of the desktop, a user can place onto the desktop a shortcut to his or her most-used files, simplifying the process of accessing the most used files, while allowing the user to use the more-cumbersome hierarchical search method for other files.

Another way of making the most-often-used files and other files easily accessible to users is to employ a certain folder that can be used as storage for documents not already categorized into another folder. For example, the conventional “My Documents” folder can be used as a storage area of files that the user uses most often or to which easy accessibility is desired. When the file will no longer be used as often or easy accessibility is no longer needed, the file may be stored in a different folder. This allows files most often used and other files to be stored in a central location, freeing the user from having to remember various locations of the most frequently used documents and other documents to which easy accessibility is desired. However, users may wish to employ the hierarchical structure of folders to store even frequently used documents, or the use of such hierarchical structure may be needed for other purposes, such as a result of the use of a server or to allow others to easily access the files.

Files to be processed by a computer system may reside on another computer system accessible via the world wide web. Here again, it can be helpful to allow a user to store the name and URL of web sites most frequently used, or those which may not be frequently used, but web sites the user would like to store for future reference. Thus, a folder of files that describe the name and URL of websites, known as the Favorites folder, may be maintained by the user using a conventional browser by using the browser to visit the site and then storing a name for the site and the URL into a Favorites folder using a command or button on the browser.

There have been developed certain devices to allow files to be transferred from one computer system to another. Conventional disks allow the transfer of files from one computer system to another. USB tokens, which are key chain-sized nonvolatile solid state devices that store significant amounts of files, have made it possible to transfer significant amounts of data through a small device that plugs into a conventional USB port and appears to the user as another disk drive, have made it easy for a user to transfer files from computer to computer in a physically secure fashion without having to transmit potentially sensitive files over a network such as the Internet.

However, the transfer of files to such devices can be a cumbersome task, requiring the user to manually locate needed files in the hierarchy of files, or give up the organizational benefits of the hierarchy and manage all needed files in a My Documents folder to allow the entire folder to be transferred, both of which are time consuming, cumbersome processes that must be repeated each time files are to be transferred to the device.

This cumbersome approach has kept such devices from realizing their full potential for reasons other than the transfer of files containing documents and other information a user may process. For example, conventional browsers store the URL and name of favorite web sites into files, which could be transferred from the computer system to a device and transferred to another computer system for use thereon, allowing access to the user's favorite web sites no matter which computer that user was using. But such transfer is cumbersome. If the user wishes to copy such files to such a device, the user must locate them in the hierarchy and copy them onto the device, then copy them into the proper folder of the other computer system, adding more time and another task to the use of such device.

Once the user copies the files to the device, the user's problems are only beginning. The use of the files on the device on a different computer system remain cumbersome. The organizational structure of the files that were transferred is lost, unless the user takes the time to reproduce it in the device, something users do not wish to take the time to do. Even then, the nomenclature of the file structure may be unfamiliar to the user unless the user reproduces the file structure exactly as it is arranged on the computer system from which the files were copied. Even then, the user will lose access to the all of the shortcuts, unless the user arranges them on the computer system to which the device has been transferred, a time consuming, cumbersome task that users will not perform, especially if the use of the device on the second computer system is expected to be temporary.

Another problem with a user who visits a computer system setting up shortcuts or favorite web sites on the computer system being visited using a portable storage device is that any existing shortcuts or favorite web sites that existed on the computer system before the user arranges them can interfere with the number of shortcuts that can be placed on the desktop without excessive clutter, or favorite web sites that can be displayed in a manner that can be easily located.

Furthermore, once the shortcuts and favorite web sites are set up on the computer system, they must be removed or they will remain on the desktop or list of favorite web sites. A user who only briefly visits a computer system would also have to remove all shortcuts added to the computer system and remove favorite web sites from the list of favorite web sites to show consideration for any other user of the visited computer system and optionally, to protect the security of the names of the shortcuts and the favorite web sites the user had installed. If the user manually attempts to install and then remove shortcuts and favorite web sites, the user may accidentally remove any of these that had existed on the computer system before the user installed his or her own, interfering with the operation of the computer system by the user who had installed the original shortcuts and favorite web sites that may be accidentally removed. For all of these reasons, potable storage devices are inconvenient to use.

The conventional MyCompanion product commercially available from the Web site of mycompanion net, which appears to have been announced on May 24, 2002, attempted to solve these problems by creating for the user of a portable storage device a temporary account on a Windows XP machine, and recreating the user's desktop, favorites and MyDocument settings onto that temporary account, and then switching to that account. Favorites and MyDocuments can be copied from a regular computer system and installed with shortcuts so that the user can use the computer system in a manner that is similar to that from which the favorites and MyDocuments were copied. However, the MyCompanion approach works only on operating systems that allow multiple accounts to be set up, excluding Windows ME or Windows 98, for example, and only then on computer systems that have enabled the administrative privileges that allow the initiation of new accounts. This can severely limit the number of computer systems on which MyCompanion can be used. Because a user would not know in advance whether the computer system which he or she may be visiting will have the capabilities needed to use the MyCompanion system, the user would not have any confidence that the system will be available when that user needs it, eliminating much of the value of the system.

What is needed is a system and method that can allow certain files stored on a portable storage device to be installed as desktop icons such as shortcuts on a computer system without interference from other desktop icons already on the computer system, can make it easy to find files transferred on the portable storage device, can allow the use of favorite web sites from one computer system by another, without requiring a user to manually set up the desktop icons for the files, without requiring the user to manually arrange the files, without requiring the user to manually transfer favorite web sites to the device from the user's computer system and then transfer them from the device to the computer system being visited and that can easily allow the user to remove the desktop icons and list of favorite web sites that had been installed and restore the desktop and list of favorites to their appearances prior to the installation of the desktop icons and favorite web sites from the portable storage device.

### BRIEF DESCRIPTION OF THE DRAWINGS

FIG. 1 is a block schematic diagram of a system for personalizing a computer system using information from another computer system and a portable storage device according to one embodiment.

FIG. 2 is a flowchart illustrating techniques for instructing a processor to reposition desktop icons according to one embodiment.

FIG. 3 is a flowchart illustrating techniques for personalizing a computer system using information from another computer system and a portable storage device according to one embodiment.

FIG. 4 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for instructing a processor to reposition desktop icons. These mechanisms and methods for instructing a processor to reposition desktop icons can enable embodiments to provide a screen at a computer system using information from another computer system and a portable storage device. The ability of embodiments to provide a screen at a computer system using information from another computer system and a portable storage device can enable users to simulate the experience of working on their own computer while working at an away computer.

In an embodiment and by way of example, a method for instructing a processor to reposition desktop icons is provided. In a method embodiment, a set of personalization information from a first computer determined to be of interest to a user and a first screen information of the first computer is persisted into a storage of a removable device. Once the removable device has been relocated from the first computer to the second computer, the first screen information retrieved from the storage of the removable device is displayed at the second computer in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon.

### System Overview

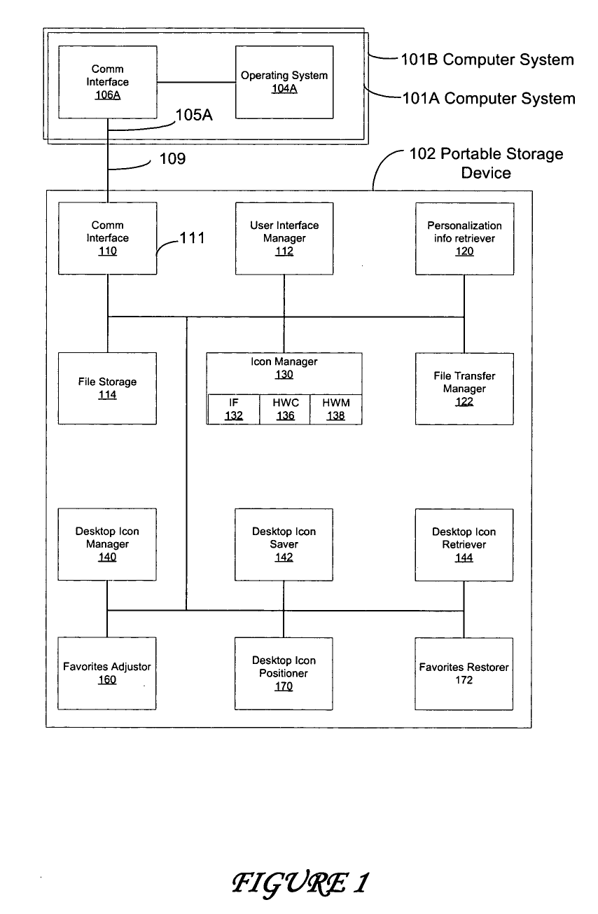

Referring now to FIG. 1, a system 100 for using information from a computer system 10A and a portable storage device 102 to personalize another computer system 101B is shown according to one embodiment. Computer systems 101A and 101B may be computer systems that are not coupled via a network, or to which access to personalization information on computer system 101A is not available from computer system 101B, either because there is not physical connection, or because the user does not have access to the personalization information on computer system 101A when the user uses computer system 101B.

Personalization information includes information regarding the appearance, operation of, or organization of some or all of the files available on, a computer system that may be altered by the user and persists from session to session, in between which, the computer can be turned off and then restarted. Some or all of the personalization information may be displayed differently from one user to another if the computer supports multiple user accounts. The personalization information described herein includes desktop icons such as shortcuts on the desktop, the arrangement of files on the desktop and in folders and means of accessing them, and Web site names and URLs used by a conventional browser, such as those described above, to display favorite web sites. However, in other embodiments, personalization information can include other information, such as the applications used to control e-mail, web access and printing capabilities, for example.

System 100 includes a portable storage device 102, such as a disk, a USB storage token (e.g. a device containing nonvolatile memory coupled to a USB port, such as the USB Memory Key commercially available from Dell Computer Systems of Round Rock, Tex., or any other device that may be coupled to a computer, and then removed from that computer in a short amount of time, such as ten seconds, relative to the removal of a permanent storage device, such as the main disk drive in a computer system. In one embodiment, the portable storage device 102 is a device that stores computer files, but is not wired to the power supply either directly, or via a single connector accessible only inside the case of the computer system to which it is attached, such as a disk drive. However, the portable storage device 102 can use the power supply of a computer system while it is connected to one, such as a USB storage token, drawing power from a power supply through a connector accessible without removing the case of the computer system.

In one embodiment, portable storage device 102 contains a communication interface 110, which includes a conventional USB hardware interface, as well as software that allows communication interface 110 to be recognized by, and communicate with, a computer system 101A or 101B, to which it is connected at the time. Communication interface 110 includes input/output 109, which may be a conventional USB connector. If portable storage device 102 contains a computer disk, communication interface 110 may not contain such hardware component or may not be present at all.

In one embodiment, when the portable storage device 102 is inserted into a computer system 101A, communication interface 110 communicates with communication interface 106A (which may be a conventional USB interface, disk drive, or other conventional communication interface) and causes the operating system 104A of the computer system 101A to recognize the portable storage device 102 as if it were a conventional disk drive coupled to computer system 101A. The user can then use conventional operating system commands to direct operating system 104A to transfer files from the file storage (not shown) of computer system 101A to file storage 114 of portable storage device 102. In one embodiment, file storage 114 is a portion of flash memory or other storage of portable storage device 102.

In one embodiment, when operating system 104A recognizes the portable storage device 102, it requests from communication interface 110 the name of a program to run and then runs that program, which resides in portable storage device 102. In such embodiment, user interface manager 112 has registered itself to communication interface 110 as the program that should be run, and operating system 104A runs user interface manager 112 when communication interface 110 so instructs. Otherwise, a user can use the operating system 104A to operate user interface manager 112 using conventional operating system commands, such as by typing to operating system 102A the drive designator used for the portable storage device 102 and the name of user interface manager 112 or using a graphical user interface that is part of operating system 102A such as the conventional WINDOWS EXPLORER program to start the program that corresponds to user interface manager 112.

### Transferring Personalization Information and Other Files to the Portable Storage Device

User interface manager 112 then displays a user interface via a conventional keyboard/monitor/mouse input/output 111 of communication interface 110 to allow the user to do any of the following: manage the transfer of files, copy personalization information from the computer system 101A or 101B with which it is in communication, provide personalization information to such computer and change or suppress the display of certain prior personalization information on that computer system, restore personalization information to the way it was before personalization information was provided to such computer system as described herein, or terminate the operation of user interface manager 112. In the description herein, the computer system from which the personalization information will be retrieved is computer system 10A and the computer system to which the personalization information will be provided is computer system 101B, however, files and the like may be transferred to portable storage device 102 from several other computer systems (not shown), and personalization information may be provided to several other computer systems (not shown).

### Manage the Transfer of Files

If the user selects the option to manage the transfer of files, user interface manager 112 signals file transfer manager 122. File transfer manager 122 provides a user interface to the user via input/output 111 to allow the user to identify the files that are to be transferred to the portable storage device 102 when the user requests the transfer of personalization information from the computer system 101A to the portable storage device 102.

In one embodiment, a user can identify files using any conventional file identification method, such as specifying files that meet any of any number of criteria. Criteria may include the folder in which a file resides, a parent folder of such a folder, the name or extension of a file, the date a file was last accessed or modified, or any other criteria.

In one embodiment, the user can also use file transfer manager 122 to specify how desktop icons such as shortcuts will be handled for files. In one embodiment, a user can instruct file transfer manager 122 to restrict or allow the installation of desktop icons onto the desktop for files that are transferred to portable storage device 102 as described above. In one embodiment, a user can instruct file transfer manager 122 to include or exclude files corresponding to desktop icons (e.g. the shortcut files themselves) from being transferred with other files when the file that is the target of the desktop icon matches the criteria specified for the transfer of files as described above.

In one embodiment, certain pre-specified criteria are stored by file transfer manager 122. For example, files changed in the last 30 days that are stored in the Desktop (and not sub folders) and files and folders in the Favorites folder may each be pre-specified criteria so that all documents meeting those criteria will be retrieved by file transfer manager 122 as described below.

File transfer manager 122 internally stores the criteria and other instructions described herein. When the user has completed specifying the criteria and instructions for the transfer of files, the user indicates to file transfer manager 122, file transfer manager 122 signals user interface manager 112 to provide the user interface described above.

### Copy Personalization Information

If the user selects the option to copy personalization information from computer system 101A to portable storage device 102, user interface manager 112 signals personalization information retriever 120. Personalization information retriever 120 signals file transfer manager 122.

### Transfer Files

File transfer manager 122 identifies files accessible to computer system 101A that match the criteria and instructions specified by the user as described above and copies the files into removable storage device 114.

Files accessible to computer system 101A may reside on computer system 101A or on a different computer system such as a server (not shown) coupled to computer system 101A. File transfer manager 122 requests from operating system 104A all files that meet the criteria and match the instructions it has internally stored as described above and stores them in file storage 114 via communication interface 110.

Before file transfer manager 122 stores files, it may build folders that do not already exist in file storage 114 that match the entire source UNC and/or path names of the files as they are retrieved from computer system 101A. To identify whether a folder should be built, file transfer manager 122 compares the source path, optionally including a UNC name, of the file it retrieves with the folders that exist in file storage and identifies any portion or all of the path that does not exist in file storage, and then creates that portion or all of the path. For example, if a file meeting the criteria and instructions is retrieved from c:.backslash.games.backslash.hopscotch.backslash. and a folder named “c” with a subfolder of “games” exists in file storage 114, file transfer manager adds as a subfolder of the “games” folder in file storage 114 a folder named “hopscotch” and stores the files retrieved from c:.backslash.games.backslash.hopscotch into the c.backslash.games.backslash.hopscotch folder in file storage 114. In one embodiment, the “c” folder is itself stored as a folder having a name that identifies the computer from which the files were transferred, which is stored as a subfolder to a folder named “Synchronized Computers”, which is a folder on the drive letter corresponding to the portable storage device 102.

When file transfer manager 122 has completed transferring all of the files that match the criteria and instructions, file transfer manager 122 signals personalization information retriever.

When signaled, personalization information retriever 120 copies into a c:.backslash.windows.backslash.favorites folder in file storage 114 the contents of the “Favorites” folder, “Favorites”, (a subfolder of the computer name folder as described above) containing the name and URL of favorite web sites used by the browser (not shown) on computer system 101A to display and obtain the URL of the user's favorite web sites. The description herein applies to MICROSOFT WINDOWS 95/98/ME/XP/2000 systems, however, other similar approaches may be used for other operating systems. Using WINDOWS or any other operating system, another folder may be designated by the user using user interface manager 112 in place of the folder described above and user interface manager 112 internally stores such designation for subsequent use, providing such names as required to transfer the files, or the folder containing favorite Web sites may be retrieved (e.g. from a registry) by personalization information retriever 120.

When personalization information retriever 120 has completed retrieving the personalization information as described above, it signals user interface manager 112, which displays the user interface described above and informs the user that portable storage device 102 may be safely removed from computer system 101A.

The user may then use the user interface provided by user interface manager 112 to terminate the operation of user interface manager 112. The user may optionally transfer additional files to, or perform other conventional file or folder operations on the folders in, file storage 114 of portable storage device 102 using operating system (for example, WINDOWS EXPLORER) 101A as described above, and the user may remove the portable storage device 102 to physically move it and to cause it to terminate its communication with computer system 101A.

The user may then transfer portable storage device 102 to another computer system 102B, which also contains communication interface 106B (not shown, but similar to communication interface 106A) and operating system 104B (also not shown, but a conventional operating system similar to operating system 104A). In one embodiment, the user connects portable storage device 102 to computer system 101B by coupling input/output 109 of communication interface 110 to input/output 105B of communication interface 106B and operating system 104B recognizes the portable storage device 102 in the same manner as operating system 104A described above.

### Providing Personalization Information—Overview

The user then starts user interface manager 112 (or user interface manager 112 is automatically started by operating system 104B using “autorun” when it recognizes portable storage device 102) as described above and user interface manager 112 provides the user interface as described above. If the user selects the option to provide personalization information to the computer system 101B, user interface manager 112 signals ID finder 132 of Icon manager 130 to obtain a handle of a listview comprising positions of the icons on the screen from the application that manages the desktop.

### Obtain a Handle of a Listview

To obtain a handle of a listview comprising positions of the icons on the screen, a FindWindow( ) and a FindWindowEx( ) API is used. When signaled by user interface manager 112, Icon manager 130 invokes these APIs to obtain icon position information. The Icon manager 130 is made up of various components 132-238, each of which will now be described.

### Find the Desktop Listview Window and Thread ID

ID finder 132 finds the thread identifier of the application that installed the desktop listview window control, then creates a hidden window. ID finder 132 will then test whether the hidden window has been created and stores the handle to this hidden window, all of which will now be described.

To find the thread identifier of the application that installed the desktop listview window control, ID finder 132 first identifies the window handle of the child of the child of the window having a class of “ProgMan” (i.e., program manager) in some operating systems, or the child of the child of the Window having the class of “WorkerW” for other operating systems. In one embodiment, to find the handle to such a window, ID finder 132 requests the handle of a window with the class “ProgMan” by calling the FindWindow( ) Win32 function call (unless otherwise noted herein, all Win32 procedures and function calls are made to operating system 104B) and if the function call returns a value of “null”, requests the handle to the window with the class “WorkerW”, using NULL as the other parameter. Once the handle to the ProgMan or WorkerW window is obtained, ID finder 132 uses the conventional Win32 function FindWindowEx( ) with the handle to the ProgMan or WorkerW window to obtain a handle to the first child window and then calls the FindWindowEx( ) function again with the child window it receives to obtain the child of the child of either the ProgMan or WorkerW window, which ID finder 132 verifies is of the class “SysListView32”.

The number of icons maybe retrieved from the listview by using a SendMessage( ) function with the LVM_GETITEMCOUNT message parameter. The listview will return the number of icons. In an embodiment, memory for storing the icon positions for subsequent reading is allocated in the address space of the listview using a VirtualAllocEx( ) function, provided however, that the process handle to the process that is hosting the ListView is known.

Using the handle to the child of the child window so located, ID finder 132 identifies the thread identifier to that window by passing the handle to the window as a parameter to the conventional Win32 function GetWindowThreadProcessID and receives the thread identifier of the process that created the desktop listview window control.

ID finder 132 provides the thread identifier of the process that created the desktop listview window control to Icon manager 130. Icon manager 130 uses ReadProcessMemory( ) and WriteProcessMemory( ) functions to receive and store the icon positions, performs certain functions described below and sets in motion the creation of a hidden window as described below.

ID finder 132 sleeps via operating system 104B for one second and then performs the Win32 FindWindow function using the expected name of the hidden window. If the function returns null, ID finder repeats the process of sleeping and calling the Win32 FindWindow function until it locates the handle to the window or the number of attempts reaches a threshold, such as ten tries, at which time an error message is provided by ID finder 132. If the handle to the hidden window is returned, ID finder 132 retains the handle to the hidden window and checks the value of the variable that describes whether the server is available as described below. In one embodiment, this check is made via a call to a portion of hidden window creator 136 that checks the variable and reports its status. If the server is available, ID finder 132 provides the handle of the hidden window to user interface manager 112.

### Create the Hidden Window Upon the First Call

Operating system 104B will call hidden window creator 136 as a result of the PostThreadMessage described above. Hidden window creator 136 may be a part of the icon manager 130, and therefore has access to the variables stored by icon manager 130 or otherwise has access to them. Hidden window creator 136 retrieves the handle to the listview stored by icon manager 130 and also retrieves the variable indicating whether the handle has been used that was initialized as described above.

If a handle has been stored, hidden window creator 136 sets the variable indicating that it has not been used to a value of false to prevent subsequent instantiation of a hidden window as described herein. Hidden window creator 136 then checks to make sure that a hidden window that is used as described below does not exist. To make this determination, hidden window creator 136 calls the conventional Win32 FindWindow function with the name of the hidden window and null for the class. If no such window exists, the FindWindow function will return a null value.

If no such window with the name or the hidden window exists as described above, hidden window creator 136 creates the window using the Win32 function CreateDialog with parameters of the handle to the icon manager 130, and a dialog resource id for a hidden dialog (which includes the name of the hidden window that will be used to locate the hidden window as described herein), null as the parent window parameter, and a callback function pointer to hidden window callback manager 138, described below. Hidden window creator 136 then repeats the FindWindow procedure described above to find the handle of the hidden window.

Hidden window creator 136 internally stores the handle to the hidden window and calls the Win32 PostThreadMessage function, with the thread identifier of icon manager 130 stored by icon manager 130 as described above, WM_NULL as the message parameter, and zeros as the wparam and lparam parameters. A “server available” variable, initialized to false at the time hidden window creator 136 is run or at some other time, is then set to true that may be tested by user interface manager 112 and hidden window creator 136 returns to operating system 104B the value of the handle obtained as described above, and the nCode, wParam and lparam parameters received by hidden window creator 136 from the operating system.

### Overview of the Operation of Hidden Window Callback Manager

Hidden window callback manager 138 is part of the Icon manager 130 and message handler 136 and therefore has access to their internally stored variables. Hidden window callback manager 138 responds to WM_CLOSE messages by closing the hidden window using the conventional Win32 DestroyWindow function. Hidden window callback manager 138 responds to WM_APP messages with an lparam value greater than zero by calling desktop icon saver 142 and providing the handle of the desktop listview window control obtained as described above. Hidden window callback manager 138 responds to WM_APP messages with an lparam value equal to zero by calling desktop icon position restorer 170 and providing the handle of the desktop listview window control obtained as described above, each described in more detail below.

### Initiate Transfer of Personalization Information

Icon manager 130 signals desktop icon manager 140. Desktop icon manager then performs the transfer of personalization information as will now be described.

### Hide Existing Desktop Icons

When signaled as described above, desktop icon manager 140 calls hidden window callback manager 138 using a WM_APP message with a parameter greater than zero, such as 1, which causes hidden window callback manager 138 to call desktop icon saver 142 to save the location of each icon on the desktop and suppress the display of each such icon.

Desktop icon saver 142 receives the handle of the desktop listview window control from hidden window callback manager 138 as described above. Desktop icon saver 142 requests the screen width and height via the conventional Win32 GetDeviceCaps function using the desktop device context and uses the Horzres and Vertres parameters to obtain the width and height of the screen in pixels. Desktop icon saver 142 defines two new work area rectangles, which are specified as a 2 element array of conventional Windows RECT structures. The first rectangle of type RECT represents pixels on the screen, using the same coordinate system (top left is 0,0) as is the convention, and the second rectangle of type RECT represents an alternate screen, with the top left coordinate one pixel greater than the screen width and bottom right coordinate 100 pixels greater than the screen width and equal to the screen height. Desktop icon saver 142 sets the work areas as areas to be used for the display by using the conventional Win32 ListView_SetWorkAreas function with parameters, the window handle of the listview control, 2 (to indicate the two work areas) and a pointer to the array of two RECTs.

Desktop icon saver 142 then obtains a count of items in the desktop listview window control using the conventional Win32 function ListView_GetItemCount with the handle to the desktop listview window control received by desktop icon saver 142 as described above and stores this count (if the count is zero, desktop icon saver 142 displays an error message and terminates).

Desktop icon saver 142 then deletes the registry locations that may have been previously used to store the desktop icon locations by calling the conventional Win32 RegDeleteKey function with HKEY_CURRENT_USER and variable containing the registry location, which in one embodiment, is: “Software.backslash.FirstPersonSoftware.backslash.PocketLogin.backslash.local.backslash.Prefs .backslash.Dips”

Desktop icon saver 142 then obtains the text and position of each item in the desktop listview window control and stores them in the registry. For each listview item (which desktop icon saver identifies using different item numbers, from 0 to the number of items in the desktop listview window control less 1), to obtain the listview text, desktop icon saver 142 calls the conventional Win32 function ListView_GetItemText and to obtain the position, desktop icon saver 142 calls the conventional Win32 function, ListView_GetItemPosition. To create a registry key and value, desktop icon saver calls the conventional Win32 function RegCreateKeyEx and stores the name of the item as the value and the position of the item as the value data, or stores the name and position using other combinations of one or more keys, values or both.

For each item, desktop icon saver 142 compares whether certain characteristics of the desktop icon (e.g. the name, or the extension of the target) correspond to a list of characteristics of icons that should remain on the desktop (e.g. icons named Internet Explorer, Network Neighborhood, etc. should remain.). If the characteristics of the desktop icon do not correspond to characteristics of those that should remain on the desktop, desktop icon saver 142 calls the conventional Win32 ListView_SetItemPosition function with a vertical coordinate equal to the vertical coordinate of the item, but uses a horizontal coordinate that is 64 pixels to the right of the screen, thus removing such desktop icons while preserving the others on the screen.

Desktop icon saver 142 then closes the registry key by calling the conventional Win32 function RegCloseKey and returns control to desktop icon manager 140.

### Redrawing the Screen

In one embodiment, each time operating system 104B receives any sort of message that causes it to redraw some or all of the screen, such messages are received by hidden window creator 136, which signals desktop icon manager 140, which signals desktop icon saver 142 to repeat the process of moving off-screen the originally-displayed desktop icons from the desktop (as described above but does not repeat the process of saving them to the registry) to ensure that they do not reappear when the screen is refreshed.

Desktop icon manager 140 then obtains the drive designator of the portable storage device 102 using the conventional Win32 function GetModuleFileName, and signals desktop icon inserter 144 with the drive designator of portable storage device 102.

### Insert Desktop Icons

When signaled by desktop icon manager 140, desktop icon inserter 144 builds and inserts onto the desktop of the computer system 101B a desktop icon (e.g. a shortcut) to each user file that is stored in the My Computer folder of file storage 114. In addition, desktop icons that were placed on the desktop of computer system 101A that pointed to a file that was transferred into file storage 114 as described above are built and added to the desktop of computer system 101B by desktop icon inserter 144, but such desktop icons have a target of the file in file storage 114. To add an icon to the desktop, desktop icon inserter 144 requests an instance of a COM object implementing the IShellLink of operating system 104B to add it to the desktop.

In one embodiment, desktop icon inserter 144 also adds to the desktop a desktop icon titled “My Computer”, with a target as the My Computer folder of removable storage device 102 that holds files transferred by file transfer manager 122.

When desktop icon inserter 144 has completed building and inserting a desktop icon for each of the files described above onto the desktop of computer system 101B, desktop icon inserter 144 signals desktop icon manager 140, which signals favorites hider/mover 160 and provides the drive designator of the portable storage device 102.

### Hide/Move Favorites

When signaled by my documents adder 152, favorites hider/mover 160 saves the value data from the entry in the registry corresponding to the Favorites directory and adjusts that value data to point to the Favorites directory in file storage 114 into which the favorites files from computer system 101A were stored as described above.

### Restoring the Computer System

The user may then use computer system 101B with the personalization information installed as described above. When the user is ready to remove the portable storage device from computer system 101B, the user signals user interface manager 112 to remove the personalization information. When signaled by the user to remove personalization information, user interface manager 112 signals desktop icon manager 140 with an indication to restore the desktop and Favorites folder. Desktop icon manager 140 calls icon manager 130 to restore the the display, by calling hidden window callback manager 138 using a WM_APP message with a parameter equal to zero. Hidden window callback manager 138 calls desktop icon position restorer 170 and provides the handle of the desktop listview window control obtained as described above.

### Restore Desktop Icons

When called by hidden window callback manager 138, desktop icon position restorer 170 receives the handle to the desktop listview window control from hidden window callback manager 138, obtains the drive designator of the portable storage device 102 as described above, and requests, (via the Win32 DeleteFile function) the operating system 104B to remove the shortcut or other similar files corresponding to the desktop icons installed by desktop icon inserter 144 (which desktop icon position restorer 170 can identify as such because they point to files having the drive designator of the portable storage device 102, and in another embodiment, desktop icon restorer uses a list of icons that were inserted by desktop icon inserter 144 that desktop icon inserter 144 builds and stores into file storage 114 as it builds the desktop icons as described above) and then calls the conventional Win32 function ListView_SetWorkAreas using as parameters, the handle to the desktop listview window control it receives, 0 and null so as to restore the work areas to their state before they were altered as described above. Desktop icon position restorer 170 then opens the registry key via the conventional Win32 function RegOpenKeyEx. Desktop icon position restorer 170 retrieves the existing window style using the conventional Win32 function GetWindowStyle, using the desktop listview window control handle as a parameter, stores the existing window style, and then disables the desktop listview's auto arrange functionality via the conventional Win32 function call SetWindowLong with the existing window style bitwise anded with the conventional Win32 constant value .about.LVS_Autoarrange as a parameter to that function.

For each desktop listview item, desktop icon position restorer 170 retrieves the name of the item using the conventional Win32 function ListView_GetItemText and uses the item text to retrieve the corresponding position from the registry and the position for that item is returned in the desktop listview window control to its value from the registry using the conventional Win32 setListViewItemPosition function, and the coordinates from the registry.

Desktop icon position restorer 170 then restores the style to the desktop listview window control using the conventional Win32 function, SetWindowLong and the original style it retrieved as described above. Desktop icon position restorer 170 then calls the conventional Win32 function, SaveListViewItemPositions and returns control to Desktop icon manager 140 via hidden window callback manager 138.

Desktop icon manager 140 destroys the hidden window by sending a WM_CLOSE message to hidden window callback manager 138 as described above. Desktop icon manager 140 then signals user interface manager 112, which signals favorites restorer 172.

### Restore Favorites

When signaled by user interface manager 112, favorites restorer 172 resets the favorites folder to point to the folder stored by favorites adjustor 160, and then signals user interface manager 112, which indicates that the removable storage device 102 may be removed from the computer system 101B.

### Synchronize Files

In one embodiment, the user may then return the portable storage device 102 to computer system 101A and select an option provided by user interface manager 112 to restore the files changed on file storage 114 to the file storage area from which the file was retrieved as described above. To perform such restoration, in one embodiment, user interface manager 112 signals file transfer manager to restore files 122. File transfer manager 122 requests operating system 104A to copy all files from their locations in file storage 102 to the corresponding locations in the file storage locations accessible to computer system 101A. In another embodiment, file transfer manager 122 transfers only those files from file storage 114 that have properties (e.g. modification date and time, size, etc) different from their corresponding files on storage locations accessible to computer system 101A.

File transfer manager 122 then synchronizes the files in the favorites folder in file storage 114 with the folder used for favorites on computer system 101A by deleting files in the favorites folder used for favorites on computer system 101A that are not in the favorites folder in file storage 114 and copying to the folder used for favorites by computer system 101A files that are in the favorites folder in file storage 114 but not in the folder used for favorites by computer system 101A or files in both locations that have different properties.

When file transfer manager 122 completes synchronizing the files and favorites, file transfer manager 122 signals user interface manager 112, which provides the user interface described above.

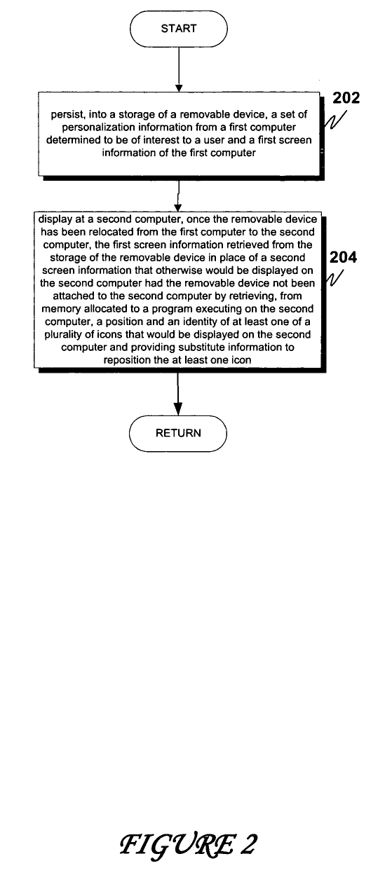

FIG. 2 is a flowchart illustrating techniques for instructing a processor to reposition desktop icons according to one embodiment. As shown in FIG. 2, a set of personalization information from a first computer determined to be of interest to a user and a first screen information of the first computer is persisted into a storage of a removable device (block 202). Once the removable device has been relocated from the first computer to the second computer, the first screen information retrieved from the storage of the removable device is displayed at the second computer in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon (block 204).

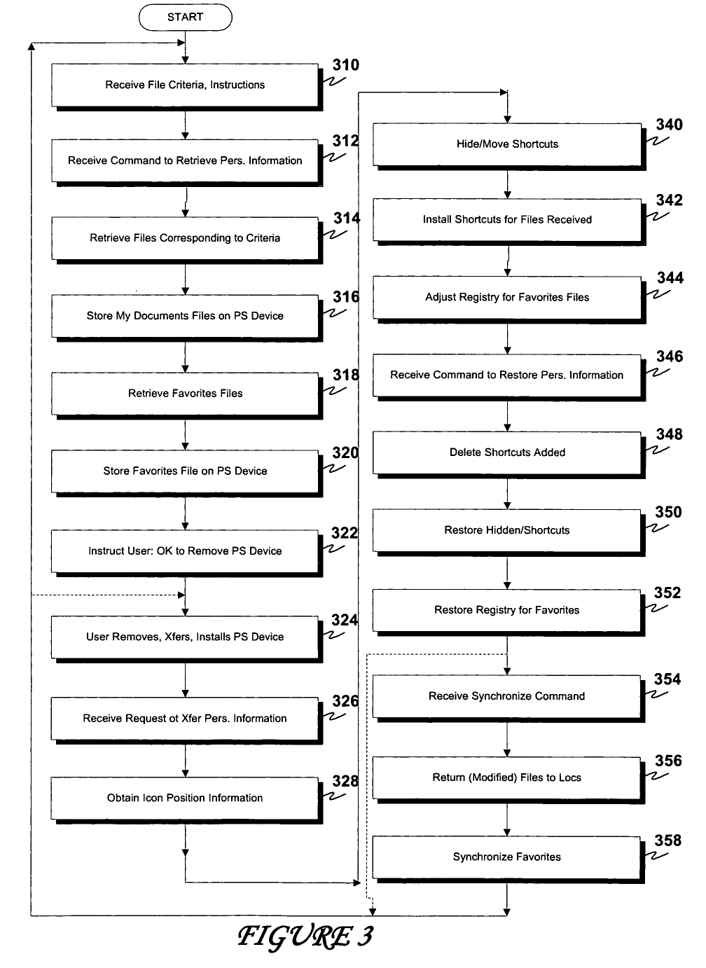

Referring now to FIG. 3, a method of personalizing a computer system using personalization information from another computer system and information on a portable storage device is shown according to one embodiment. One or more file criteria and instructions may be received 310 to identify which files should be transferred for storage on a portable storage device. A command to retrieve personalization information may be received 312 as described above. In response to the command received in step 312, steps 314-322 are performed.

Files may be retrieved 314 from a computer to which the portable storage device is in communication and stored 316 on the portable storage device. Step 316 may include reproducing the folder structure from which the files were retrieved, including all parent folders. One or more favorites files may be retrieved 318 from a computer to which the portable storage device is in communication and stored 320 on the portable storage device. The user may be instructed 322 that it is safe to remove the portable storage device.

The user may then disconnect the portable storage device from the computer system to which it is connected, transfer the portable storage device, and then connect it to a different computer system 324. A request is received 326 to transfer personalization information to the computer system to which the portable storage device has been installed. Steps 328-344 are performed in response to this command.

A icon manager may interface with processes managing icon positions as described above to obtain icon position information. Some or all of the existing desktop icons are hidden, moved, or both as described above 340. Shortcuts or other desktop icons for files in the My Documents folder on the portable storage device and are installed 342 as described above and other desktop icons may be installed as described above, such as icons corresponding to icons on the desktop on the first computer system that point to files that meet the file criteria specified above. An icon representing the portable storage device may be installed as part of step 342.

The registry value data corresponding to the browser favorites folder is saved and then adjusted to point to the folder to which the favorites were stored on the portable storage device 344.

A command is received 346 to restore the personalization information of the computer system to which the portable storage device is in communication, and steps 348-352 are performed in response. Desktop icons added in step 332 are deleted 348 and desktop icons hidden, moved or both in step 330 are un-hidden, moved back to their original locations, or both 350.

The registry entry for the folder holding the favorites files adjusted in step 344 is restored 352 to point to the folder that it pointed to prior to step 344.

The user may then return the portable storage device to the computer from which the files were copied. A command may be received 354 to synchronize the files. Files and favorites are synchronized 356, 358 as described above.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for instructing a processor to reposition desktop icons as discussed herein.

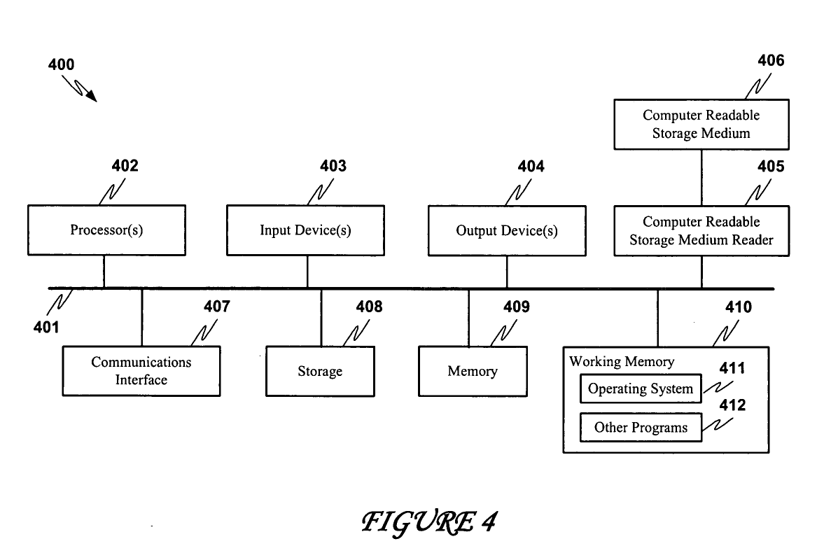

FIG. 4 illustrates a processing system 400, which can comprise one or more of the elements of FIG. 1. Turning now to FIG. 4, a computing system is illustrated that may comprise one or more of the components of FIG. 1. While other alternatives might be utilized, it will be presumed for clarity sake that components of the systems of FIG. 1 are implemented in hardware, software or some combination by one or more computing systems consistent therewith, unless otherwise indicated.

Computing system 400 comprises components coupled via one or more communication channels (e.g., bus 401) including one or more general or special purpose processors 402, such as a Pentium®, Centrino®, Power PC®, digital signal processor (“DSP”), and so on. System 400 components also include one or more input devices 403 (such as a mouse, keyboard, microphone, pen, and so on), and one or more output devices 404, such as a suitable display, speakers, actuators, and so on, in accordance with a particular application. (It will be appreciated that input or output devices can also similarly include more specialized devices or hardware/software device enhancements suitable for use by the mentally or physically challenged.)

System 400 also includes a machine readable storage media reader 405 coupled to a machine readable storage medium 406, such as a storage/memory device or hard or removable storage/memory media; such devices or media are further indicated separately as storage 408 and memory 409, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 407 may also be included, such as a modem, DSL, infrared, RF or other suitable transceiver, and so on for providing inter-device communication directly or via one or more suitable private or public networks or other components that may include but are not limited to those already discussed.

Working memory 410 further includes operating system (“OS”) 411 elements and other programs 412, such as one or more of application programs, mobile code, data, and so on for implementing system 400 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 412 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 408 or memory 409) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for instructing a processor to reposition a desktop icon, the method comprising:
persisting, into a storage of a removable device, a set of personalization information from a first computer determined to be of interest to a user and a first screen information of the first computer;
displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon.

2. The method of claim 1, further comprising:
persisting into the storage of the removable device at least one change made to the set of personalization information at the second computer to update the set of personalization information at the first computer once the removable device has been relocated from the second computer to the first computer.

3. The method of claim 1, wherein persisting, into a storage of a removable device, a set of personalization information from a first computer determined to be of interest to a user and a first screen information of the first computer includes:
persisting, into a storage of a removable device, at least one of an email for the user, a web browser favorite for the user, wallpaper, a file, and a document for the user.

4. The method of claim 1, wherein displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon includes:
determining whether at least one program corresponding to at least one icon of the first screen information is present on the second computer prior to displaying an icon of the first screen information at the second computer.

5. The method of claim 1, wherein displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon includes:
providing at the second computer, once the removable device has been relocated from the first computer to the second computer, the set of personalization information retrieved from the storage of the removable device in place of similar information that otherwise would be provided on the second computer had the removable device not been attached to the second computer.

6. The method of claim 5, wherein providing at the second computer, once the removable device has been relocated from the first computer to the second computer, the set of personalization information retrieved from the storage of the removable device in place of similar information that otherwise would be provided on the second computer had the removable device not been attached to the second computer includes:
providing at the second computer, at least one document from a “my documents” folder retrieved from the storage of the removable device in place of at least one document from a “my documents” folder resident on the second computer once the removable device has been relocated from the first computer to the second computer.

7. The method of claim 2, further comprising:
removing any indication of the at least one change made to the set of personalization information from the second computer such that the at least one change is not detectable at the second computer once the removable device has been removed from the second computer.

8. The method of claim 2, wherein persisting into the storage of the removable device the at least one change made to the set of personalization information at the second computer to update the set of personalization information at the first computer once the removable device has been relocated from the second computer to the first computer includes:
persisting into the storage of the removable device the at least one change in accordance with controlling a version of the at least one change based upon a state of the first computer.

9. A machine-readable medium carrying one or more sequences of instructions for instructing a processor to reposition a desktop icon, which instructions, when executed by one or more processors, cause the one or more processors to carry out the steps of:
persisting, into a storage of a removable device, a set of personalization information from a first computer determined to be of interest to a user and a first screen information of the first;
displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon.

10. The machine-readable medium as recited in claim 9, further comprising instructions for carrying out the step of:
persisting into the storage of the removable device at least one change made to the set of personalization information at the second computer to update the set of personalization information at the first computer once the removable device has been relocated from the second computer to the first computer.

11. The machine-readable medium as recited in claim 9, wherein the instructions for carrying out the step of persisting, into a storage of a removable device, a set of personalization information from a first computer determined to be of interest to a user and a first screen information of the first computer include instructions for carrying out the step of:
persisting, into a storage of a removable device, at least one of an email for the user, a web browser favorite for the user, wallpaper, a file, and a document for the user.

12. The machine-readable medium as recited in claim 9, wherein the instructions for carrying out the step of displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon include instructions for carrying out the step of:
determining whether at least one program corresponding to at least one icon of the first screen information is present on the second computer prior to displaying an icon of the first screen information at the second computer.

13. The machine-readable medium as recited in claim 9, wherein the instructions for carrying out the step of displaying at a second computer, once the removable device has been relocated from the first computer to the second computer, the first screen information retrieved from the storage of the removable device in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon include instructions for carrying out the step of:
providing at the second computer, once the removable device has been relocated from the first computer to the second computer, the set of personalization information retrieved from the storage of the removable device in place of similar information that otherwise would be provided on the second computer had the removable device not been attached to the second computer.

14. The machine-readable medium as recited in claim 13, wherein the instructions for carrying out the step of providing at the second computer, once the removable device has been relocated from the first computer to the second computer, the set of personalization information retrieved from the storage of the removable device in place of similar information that otherwise would be provided on the second computer had the removable device not been attached to the second computer include instructions for carrying out the step of:
providing at the second computer, at least one document from a “my documents” folder retrieved from the storage of the removable device in place of at least one document from a “my documents” folder resident on the second computer once the removable device has been relocated from the first computer to the second computer.

15. The machine-readable medium as recited in claim 10, further comprising instructions for carrying out the step of:
removing any indication of the at least one change made to the set of personalization information from the second computer such that the at least one change is not detectable at the second computer once the removable device has been removed from the second computer.

16. The machine-readable medium as recited in claim 10, wherein the instructions for carrying out the step of persisting into the storage of the removable device the at least one change made to the set of personalization information at the second computer to update the set of personalization information at the first computer once the removable device has been relocated from the second computer to the first computer include instructions for carrying out the step of:
persisting into the storage of the removable device the at least one change in accordance with controlling a version of the at least one change based upon a state of the first computer.

17. An apparatus for instructing a processor to reposition a desktop icon, comprising:
an interface to connect with a computer; and
a storage,
into which a set of personalization information from a first computer determined to be of interest to a user and a first screen information comprising a position and an identity of at least one of a plurality of icons displayed on the first computer; and
from which the first screen information may be retrieved, once the apparatus has been relocated from the first computer to a second computer, for display at a second computer, in place of a second screen information that otherwise would be displayed on the second computer had the removable device not been attached to the second computer by retrieving, from memory allocated to a program executing on the second computer, a position and an identity of at least one of a plurality of icons that would be displayed on the second computer and providing substitute information to reposition the at least one icon.
